(19) United States
(12) Patent Application Publication
(10) Pub. No.: US 2025/0330488 A1
(43) Pub. Date: Oct. 23, 2025

(54) Data Exfiltration Monitoring Using Hash Values

(71) Applicant: NetApp, Inc., San Jose, CA (US)

(72) Inventors: Mesfin Dema, Allen, TX (US); Muneem Shahriar, Sunnyvale, CA (US); Jian Jian, Cupertino, CA (US); Phani Srikanth Bhavani Sankar, Hyderabad (IN); Yogita Verma, Bangalore (IN); Arunkumar Gururajan, Sammamish, WA (US)

(21) Appl. No.: 18/785,888

(22) Filed: Jul. 26, 2024

(30) Foreign Application Priority Data
Apr. 23, 2024 (IN) 202441032032

(51) Int. Cl. H04L 9/40

(52) U.S. Cl. CPC H04L 63/1441; H04L 63/1408

(57) ABSTRACT

The disclosure describes a data protection service that generates semantic descriptions of protected data volumes. The data protection service queries a monitoring service with the generated semantic descriptions. The monitoring service responds to the queries with indications of whether and data items on the dark web match the semantic descriptions. When a query receives a positive response from the monitoring service, the data protection service iteratively refines the semantic description and queries the monitoring service with the refined semantic descriptions until a breach is detected. Once a breach is detected, the data protection service initiates a mitigation action.

### BACKGROUND

Data breaches are prevalent in enterprise systems that handle substantial amounts of data. These breaches involve malicious actors stealing sensitive information, such as Personal Identifiable Information (PII) and Intellectual Property (IP), which they then sell for illicit purposes such as identity theft, fraud, and IP theft. To facilitate these illegal transactions, such data is often sold and distributed on dark web markets. Existing enterprise systems rely on monitoring systems to detect if their data appears on the dark web, indicating a potential data breach.

Existing monitoring systems identify key values (e.g., social security numbers) for sale on the dark web. However, existing systems face challenges in identifying exfiltrated data when the data is unstructured (e.g., plain text, drawings, images, and videos). In such cases, a direct key value search may be time consuming (e.g., where it takes additional processing to identify key values in unstructured text), or not possible (e.g., where a document does not contain key values). Furthermore, when an enterprise system manages a vast pool of data, it becomes resource intensive and expensive to submit a separate query for each data item, especially since monitoring services may charge per query.

### SUMMARY

The technology described herein includes a data protection service that generates semantic descriptions of protected data volumes and submits these descriptions in queries to a monitoring service. The monitoring service evaluates the queries to determine if any data items on the dark web match the semantic descriptions. When the data protection service receives a positive response, the data protection service progressively refines the semantic description and re-queries the monitoring service, continuing the iterative cycle until the scope of the semantic description is sufficiently narrow to submit a specific query or initiate a mitigation action.

This Summary introduces a selection of concepts in a simplified form that are further described below in the Technical Disclosure. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operational environment in an implementation.

FIG. 2 illustrates a data protection process in an implementation.

FIG. 3 illustrates an operational scenario in an implementation.

FIG. 4 illustrates another operational environment in an implementation.

FIG. 5 illustrates another data protection process in an implementation.

FIG. 6 illustrates another operational scenario in an implementation.

FIG. 7 illustrates another data protection process in an implementation.

FIG. 8 illustrates another operational scenario in an implementation.

FIG. 9 illustrates another data protection process in an implementation.

FIG. 10 illustrates another operational scenario in an implementation.

FIG. 11 illustrates another data protection process in an implementation.

FIG. 12 illustrates another operational scenario in an implementation.

FIG. 13 illustrates another data protection process in an implementation.

FIG. 14 illustrates another operational scenario in an implementation.

FIG. 15 illustrates another data protection process in an implementation.

FIG. 16 illustrates another operational scenario in an implementation.

FIG. 17 illustrates a computing system suitable for implementing the various operational environments, architectures, environments, processes, scenarios, sequences, and frameworks discussed below with respect to the other Figures.

### DETAILED DESCRIPTION

A data protection service is described herein that detects data breaches by querying a monitoring service with semantic descriptions of a data volume. The data protection service queries the monitoring service with an initial semantic description, applicable to a portion of data items in a data volume to determine if data items matching the semantic description have been identified on the dark web. If the monitoring service returns positive results (i.e., indicating that dark web data items matching the description have been identified), the data protection service iteratively queries the monitoring service with refined semantic descriptions until a breach is identified. A refined semantic description narrows the scope of documents identified. For example, where the initial semantic description is “design documents for self-driving cars,” a refined semantic description might be “design documents for vision systems in self-driving cars.” If positive results are received, the monitoring service may further refine the semantic description to be “human figure recognition and localization.” In each iteration, the refined semantic query describes a progressively smaller set of data items until a breach is identified. A breach may be identified, for example, when the likelihood that a breach occurred surpasses a predefined threshold. Once the breach is identified, the data protection service performs a mitigation action. The mitigation action may include confirming the breach by submitting a specific query (such as a hash value query or a key value query) to the data monitoring service. Once the breach is confirmed, the data protection service may generate and provide an exposure report for the enterprise system that owns the data volume. The exposure report may include information about the extent of the breach and an identification of the exfiltrated data items. Once the enterprise system receives the exposure report, it may take further action by notifying affected end-users (i.e., users whose data was exfiltrated) and shutting down their access to the enterprise system to prevent the spread of ransomware.

Such an implementation may be especially advantageous in identifying data breaches for large data volumes containing sensitive documents that may not include key value identifiers. When data such as intellectual property (which may be included in design drawings, images, videos, and unstructured text) is exfiltrated, traditional key value searches may be ineffective. This is compounded by the sheer volume of data managed by enterprises, making it impractical to query each item individually. Implementations disclosed herein alleviate these issues by utilizing progressively refined semantic descriptions, thus narrowing in on data items that may have been exfiltrated without submitting queries for each individual data item in the data volume. This progressive narrowing in scope effectively reduces the number of queries used to identify data items that have been exfiltrated. This results in computer resource savings and may also result in cost savings where the monitoring service levies a charge per query.

Various embodiments of the present technology provide for a wide range of technical effects, advantages, and/or improvements to computing systems and components. For example, various embodiments may include one or more of the following technical effects, advantages, and/or improvements: 1) non-routine and unconventional dynamic implementation of a data protection service; 2) non-routine and unconventional operations for querying a dark web monitoring service; and/or 3) non-routine and unconventional use of a dark web monitoring service.

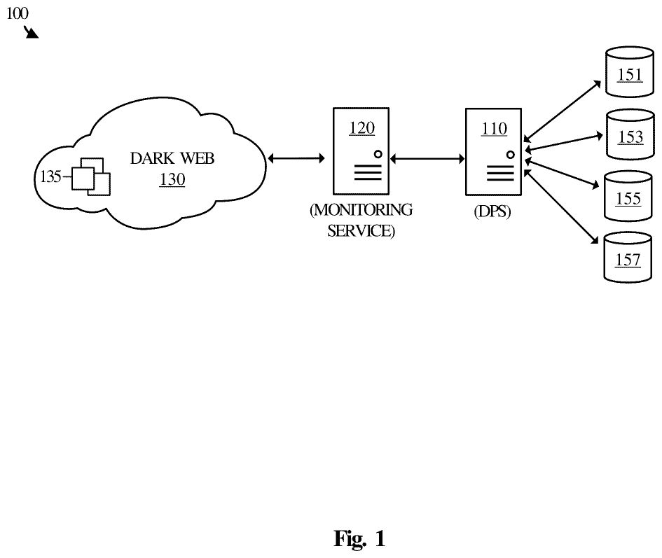

FIG. 1 illustrates operational environment 100 in an implementation. Operational environment 100 includes data protection service 110, monitoring service 120, dark web 130, and data volumes 151, 153, 155, 157. Dark web 130 contains exfiltrated data items 135. Data protection service 110 is in communication with monitoring service 120 and data volumes 151, 153, 155, 157. Monitoring service 120 is in communication with data protection service 110 and dark web 130.

Data volumes 151, 153, 155, 157 represent aggregations of data collected and stored for various enterprise systems. Data volumes 151, 153, 155, 157 may contain sensitive information, including Personal Identifiable Information (PII) and Intellectual Property (IP). Data in data volumes 151, 153, 155, 157 is subject to a data breach when a malicious actor illicitly obtains the data, often in order to put the stolen data for sale on dark web 130. Data protection service 110 works in conjunction with monitoring service 120 to identify such data breaches, as discussed herein.

Data protection service 110 is representative of a software service that provides data protection services for data volumes 151, 153, 155, 157. Data protection service 110 is capable of querying monitoring service 120 to determine whether data volumes 151, 153, 155, 157 have been exfiltrated in a data breach. Data protection service 110 is further capable of receiving, from monitoring service 120, results indicating whether a data breach has occurred. If the results indicate that a data breach has occurred, data protection service 110 is capable of initiating a mitigation action.

Monitoring service 120 is representative of a software service that is capable of monitoring dark web 130 to identify exfiltrated data items 135. Monitoring service 120 provides, to data protection service 110, indications that data stored in data volumes 151, 153, 155, 157, has been subject to a data breach. Monitoring service 120 is configured to respond to queries from data protection service 110 with indications of whether data items indicated in the queries (e.g., by semantic descriptions, hash values, key values, etc., as described herein) have been identified on dark web 130. Monitoring service 120 may reply to queries with a positive or negative response (e.g., “YES” or “NO,”), according to some embodiments.

Dark web 130 is representative of a collection of anonymized websites accessible by a specialized browser (such as a Tor browser). Dark web 130 is often used for illicit activities, including the sale of stolen data. Data (represented by exfiltrated data items 135) stolen from data volumes 151, 153, 155, 157 may be for sale on dark web 130.

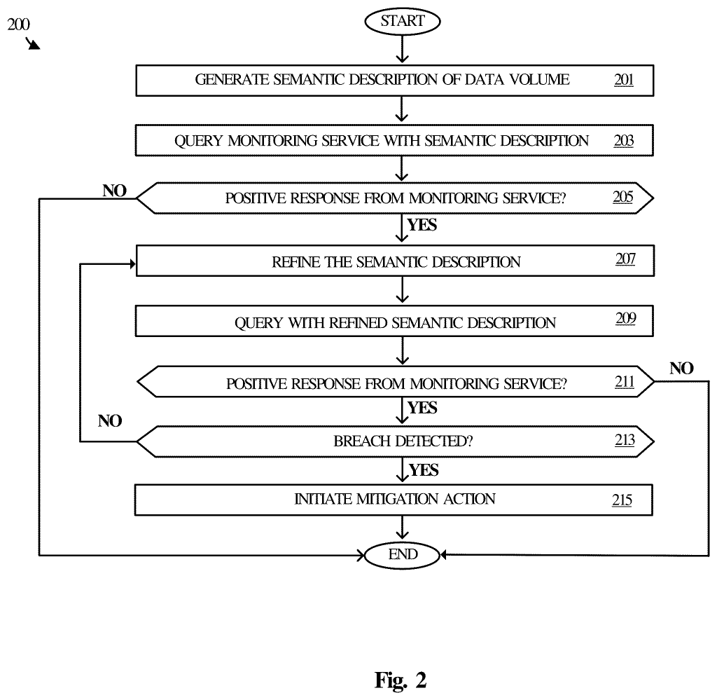

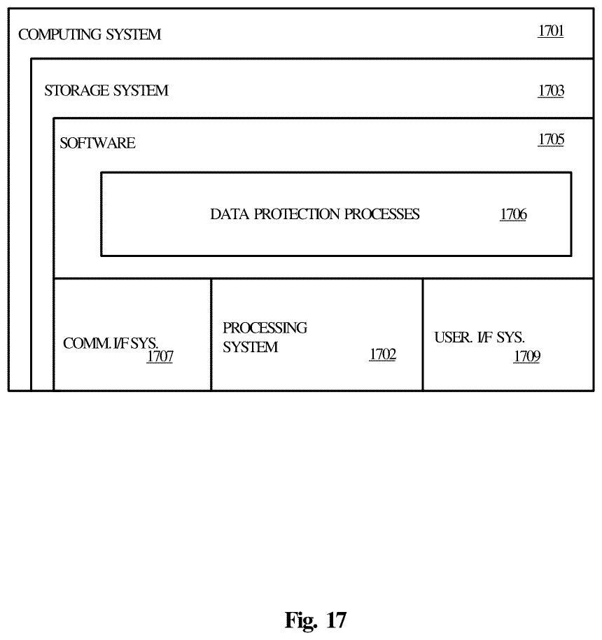

FIG. 2 illustrates a data protection process performed by data protection service 110, represented by process 200. Process 200 is employed by a computing device, an example of which is provided by computing system 1701 of FIG. 17. Process 200 may be implemented in program instructions (software and/or firmware) by one or more processors of the computing device. The program instructions direct the computing device to operate as follows, referring parenthetically to the steps in FIG. 2.

To begin, data protection service 110 generates a semantic description of a data volume such as data volume 151 (step 201). Generating the semantic description of a data volume may include generating a natural language description of a portion of data items within data volume 151. For example, if data volume 151 includes a set of data items relating to self-driving cars, the generated semantic description might be “design documents relating to self-driving cars made by X company.” To generate the semantic description, data protection service 110 may utilize various techniques such as machine learning, Natural Language Processing (NLP), semantic analysis, rules-based systems, and hybrid approaches.

Data protection service 110 then queries monitoring service 120 with the semantic description (step 203) to determine if documents matching the semantic description have been identified on dark web 130. In the present example, data protection service 110 may request an indication of whether monitoring service 120 has found, on dark web 130, any design documents relating to self-driving cars manufactured by X company.

Data protection service 110 receives results from monitoring service 120 and determines if the results indicate a positive response to the query (step 205). Monitoring service 120 may provide either positive or negative responses to queries. A negative response (i.e., the answer is “NO”) indicates that the documents in question (e.g., the design documents relating to self-driving cars) have not been exfiltrated. As such, process 200 ends after a “NO” response at step 205. If a positive response is received (i.e., the answer is “YES”), monitoring service 120 has identified an exfiltrated data item 135 matching the description, and process 200 continues at step 207.

Upon receiving a positive response, data protection service 110 refines the semantic description (step 207). Refining the semantic description may include generating a natural language description that is more specific than the first semantic description generated in step 201. As such, the refined semantic description generated in step 207 may apply to a smaller set of data items in data volume 151 as compared to the set of documents identified in the first semantic description. Continuing with the self-driving cars example, a refined semantic description might be “vision systems in self-driving cars made by X company.” If data volume 151 includes one-thousand design documents relating to self-driving cars, a smaller number (e.g., two-hundred) of those documents may be related to vision systems.

Refining the semantic description in step 207 may further include generating multiple natural language descriptions, each identifying a different sub-category of documents within the broader set of documents associated with the first semantic description (generated in step 201). In the self-driving car example, the multiple different sub-categories might include vision systems, acceleration control, navigation, etc. As such, each document in the broader set of documents in data volume 151 may be broken out into smaller sub-categories. This procedure increases efficiency in the process of identifying exfiltrated data items, as discussed further below.

After refining the semantic description, data protection service 110 queries monitoring service 120 with the refined semantic description (step 209) to determine if data items matching the refined semantic description have been identified on dark web 130. Querying monitoring service 120 may include submitting a separate query for each of the subcategories of the refined semantic description that have been identified. For example, data protection service 110 may submit separate queries for vision systems, speed control systems, and navigation systems to determine if any documents matching the respective descriptions have been identified on dark web 130.

Data protection service 110 receives results from monitoring service 120 and determines if the results indicate a positive response to the query/queries (step 211). A negative response (i.e., the answer is “NO”) indicates that the data items matching the refined semantic description (e.g., the design documents relating to navigation systems in self-driving cars) have not been exfiltrated. As such, process 200 ends after a “NO” response at step 205. If a positive response is received from monitoring service 120 (i.e., the answer is “YES”) process 200 continues at step 213.

It is noted that step 211 may include receiving a “YES” response for one subcategory (e.g., vision systems) and a “NO” response for another subcategory (e.g., navigation systems). Process 200 continues with respect to subcategories for which a “YES” response is received, while process 200 ends with respect to the subcategories for which a “NO” is received. As such, process 200 narrows in on data items in data volume 151 for which a breach might have occurred by eliminating categories of data items that were probably not exfiltrated in a breach. This enhances the efficiency of process 200, since data protection service 110 does not submit a separate query for each data item.

For each subcategory which has received a positive response, data protection service 110 determines if a breach has been detected (step 213). Determining if a breach has been detected may include determining if the refined semantic description was specific enough to create a likelihood that the data items described by the refined semantic description were exfiltrated. To detect a breach, data protection service 110 may calculate a percentage likelihood that a data item in data volume 151 was exfiltrated, based on the specificity of the refined semantic query. A breach may be detected if the percentage exceeds a predetermined threshold percentage. The predetermined threshold percentage may be 75%, 80%, 90%, or any other percentage suitable for breach detection. As an example, data volume 151 may include five design documents having the refined semantic description “three-dimensional human pose estimation in computer vision systems for self-driving cars manufactured by X company.” If monitoring service 120 responds “YES” to a query with this refined semantic description, data protection service 110 may determine that there is a high likelihood (e.g., 85%) that at least one of the five documents was exfiltrated. If this likelihood exceeds the predetermined threshold (e.g., 80%), data protection service 110 may detect a data breach.

If it is not determined that a breach has occurred (i.e., the “NO” decision), the process returns to 205. This decision branch creates an iterative process of refining the semantic description and querying the monitoring service until the refined semantic description is specific enough to make a breach determination at step 213. In the self-driving car example, the semantic descriptions can be iteratively refined at step 207. For example, subcategories within “vision systems” may include “human figure recognition and localization,” and “dynamic object tracking.” Data protection service 110 may detect a breach when the subcategory is sufficiently specific (for example, a subcategory associated with 1 to 10 data items in data volume 151). If a breach is detected at step 213, process 200 continues at step 215.

When a breach is detected, data protection service 110 initiates a mitigation action (step 215). Once data protection service 110 initiates the mitigation action, data protection service 110 performs the mitigation action. In some implementations, initiating the mitigation action includes verifying that a breach has occurred for one or more data items matching the refined semantic description. Verifying that the breach occurred may include submitting a specific query to monitoring service 120. The specific query may include a hash value specifically identifying the data item or a portion of the data item. To create the specific query, data protection service 110 may first generate the hash value. Each hash value is a unique identifier for a data item, which monitoring service 120 generates using a hashing algorithm.

The term “hash value” used in this description refers to a code generated from a data item or a portion of a data item (e.g., a specific block of text) using a mathematical process called “hashing.” Hashing is accomplished using a hashing algorithm that generates the code specifically identifying the data item (or portion of the data item). Hash values are often in hexadecimal format but may have other formats such as binary. Hash values may be used, for example, to determine if a data item has been altered (since an altered data item would result in a different hash value). The present disclosure describes the use of hash values to determine if data items have been exfiltrated to dark web 130. Specifically, an exfiltration is identified if a dark web data item 135 has a hash value matching a hash value of an enterprise data item from data volume 151.

The specific query submitted to monitoring service 120 asks if monitoring service has found any data items on dark web 130 with a matching hash value. Monitoring service 120 may respond to the query utilizing the same hashing algorithm (used on exfiltrated items 135) as data protection service 110 (used on data items in data volume 151, 153, 155, 157). Thus, monitoring service 120 separately generates hash values for data items obtained from dark web 130. If monitoring service 120 responds with an indication that a matching hash value has been found, data protection service 110 has verified that the data item has likely been exfiltrated in a data breach. If monitoring service 120 responds with a negative indication, data protection service 110 may try alternate means of verifying the breach or may calculate a confidence level that the data item has been exfiltrated. It is noted that a negative response does not preclude a breach, since data items that have been modified may have different associated hash values.

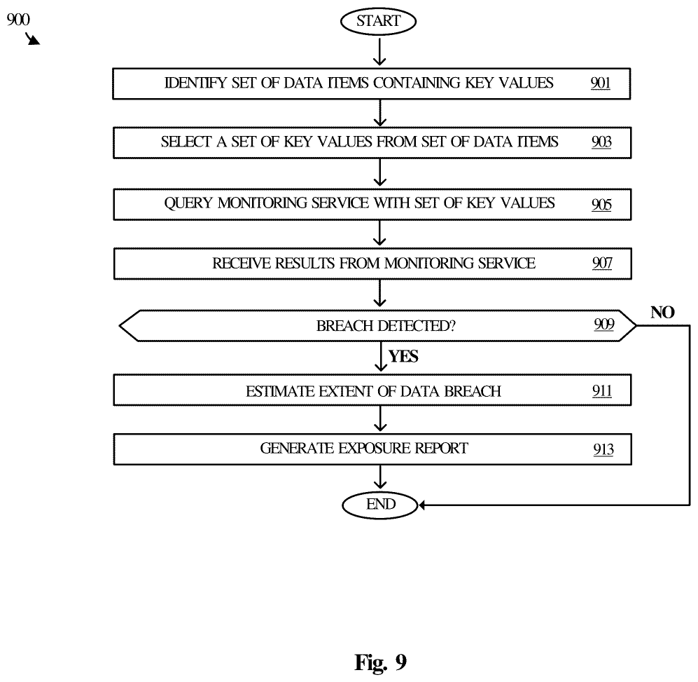

In some implementations, the specific query may include a key value query to asking monitoring service 120 if it has identified the key value in dark web 130. A key value is a piece of data within a specific category. For example, key values associated with PII include social security numbers (SSNs), addresses, email addresses, etc. (See the description of process 900 of FIG. 9 below for further discussion on key values.) Data items in data volumes 151, 153, 155, 157, may contain key values that are stolen and sold on dark web 130. For example, stolen SSNs are often sold and purchased on dark web 130 to facilitate identity theft. If monitoring service 120 responds with an indication that the key value has been found, data protection service 110 has verified that the data item has likely been exfiltrated in a data breach. If monitoring service 120 responds with a negative indication, data protection service 110 may try alternate means of verifying the breach or may calculate a confidence level that the data item has been exfiltrated.

In some implementations the mitigation action of step 215 may include generating (at data protection service 410) an exposure report for the owner of the data volume (e.g., data volume 151). The exposure report may include the data items found on the dark web, and an estimated percentage of files that have been exfiltrated, for example. Data protections service 110 provides generated exposure reports to the owners of data volume 151. Upon receipt, the owner may notify affected end users and shut down their access to prevent spreading the cause of the breach (e.g., ransomware) to other users.

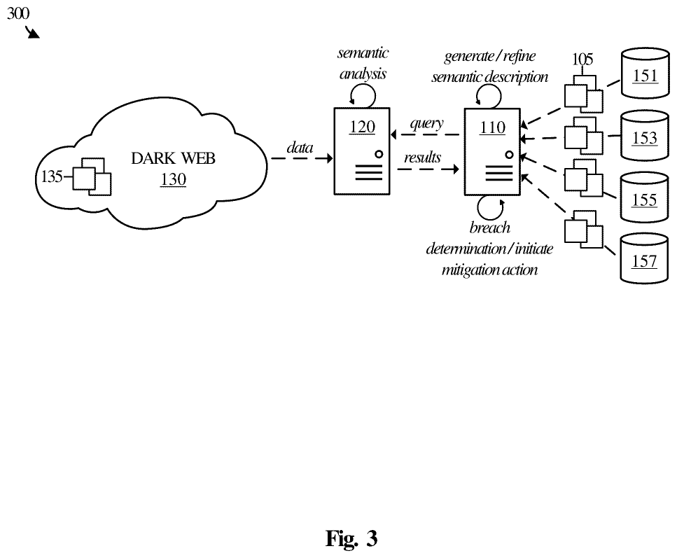

FIG. 3 illustrates an operational scenario of an application of process 200 in the context of operational environment 100 in an implementation, represented by scenario 300. Scenario 300 includes data protection service 110, monitoring service 120, dark web 130, and data volumes 151, 153, 155, 157.

Data protection service 110 generates semantic descriptions and refines the semantic descriptions, as discussed in process 200 above in steps 201 and 207 respectively. The semantic description is generated based on data items 105 read from data volumes 151, 153, 155, 157. Data protection service 110 also makes breach determinations and initiates mitigation actions, as discussed in process 200 above in steps 213 and 215, respectively. Data protection service 110 submits queries to monitoring service 120 including the semantic descriptions and receives results from monitoring service 120.

Monitoring service 120 receives the queries submitted by data protection service 110. Monitoring service performs a semantic analysis to determine if any exfiltrated data items 135 are identified that align with the semantic description. To perform the semantic analysis, monitoring service 120 generates its own semantic descriptions of exfiltrated data items 135 scraped from dark web 130 and determines if the semantic descriptions in the queries align with the semantic descriptions received from monitoring service 120. After performing the semantic analysis, monitoring service 120 provides the results of the semantic analysis to data protection service 110. In some implementations, the results may be formatted as a binary positive-or-negative response (e.g., a “YES” response indicating that exfiltrated data items 135 aligning with the semantic description have been identified, or a “NO” response indicating that no exfiltrated data item 135 aligns with the description). Based on the results, data protection service 110 makes breach determinations and initiates mitigation actions (as described above in steps 213 and 215 of process 200).

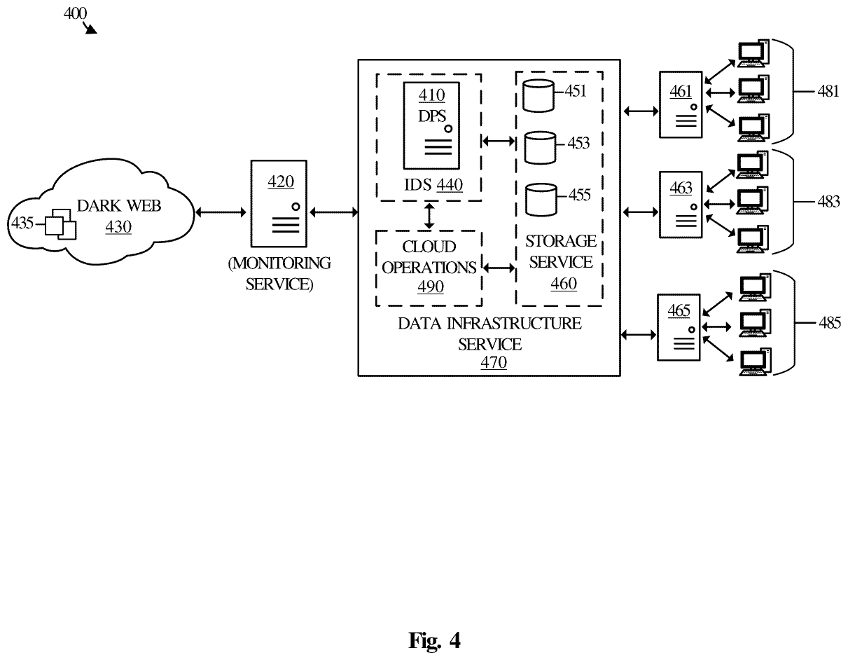

FIG. 4 illustrates operational environment 400 in an implementation. Operational environment 400 includes data infrastructure service 470, monitoring service 420, dark web 430, enterprise systems 461, 463, 465, and users 481, 483, 485. Data infrastructure service 470 includes integrated data services 440, storage service 460, and cloud operations 490. Integrated data services 440 includes data protection service 410. Storage service 460 includes storage volumes 451, 453, 455. Data infrastructure service 470 is in communications with monitoring service 420 and enterprise systems 461, 463, 465. Monitoring service 420 is in communication with dark web 430 and data infrastructure service 470. Within data infrastructure service 470, integrated data services 440 is in communication with storage service 470 and cloud operations 490. Storage service 460 is in communication with integrated data services 440 and cloud operations 490.

Enterprise systems 461, 463, 465 manage data for large organizations and can be deployed on-premises or on the cloud. Users 481, 483, 485 are representative of end users that generate the data managed by enterprise systems 461, 463, 465. While a limited number of users are shown in FIG. 4 for representative purposes, organizations may serve many users who generate a large amount of data. Enterprise systems 461, 463, 465 perform data management functions, including storing and maintaining data (e.g., in data volumes 451, 453, 455). Enterprise systems 461, 463, 465 utilize data infrastructure service 470 to facilitate secure and efficient storage of data in data volumes 451, 453, 455, on the cloud or on premises.

Data infrastructure service 470 is a software service that facilitates efficient and secure storage solutions for enterprise systems 461, 463, 465. Data infrastructure service 470 includes data protection service 410, storage service 460 and cloud operations 490.

Integrated data services 440 is representative of a collection of integrated software-based services for managing substantial amounts of data. Integrated data services 440 include data protection service 410, which is described in detail below. Integrated data services 440 may additionally include services for scaling applications and data on the cloud, services for unifying cloud and on-premises data storage, and services for facilitating an efficient utilization of storage resources. Integrated data services 440 interacts with storage service 460 to perform the data management functions. For example, data protection service 410 may read data in data volumes 451, 453, 455 to generate queries for monitoring service 420, as described herein.

Storage service 460 is a service that facilitates storage of data in data volumes 451, 453, 455 for enterprise systems 461, 463, 465. Data volumes 451, 453, 455 may be stored in servers (represented, for example, by computing system 1701 of FIG. 17) and may be located on premises (i.e., operated by enterprise systems 461, 463, 465) or on the cloud.

Cloud operations 490 is representative of software-based services that optimize data management in cloud environments. Cloud operations 490 may include, for example, a service for integrating multi-cloud environments (where an organization utilizes multiple cloud providers), a disaster protection service for virtual machine workloads, a tiering service for optimizing the cost of storage, and a classification service. Cloud operations 490 is in communication with storage service 460 and integrated data services 410 to perform cloud-based storage services with respect to data volumes 451, 453, 455.

Data protection service 410 is a software-based service that performs data protection functions for data volumes 451, 453, 455. Data protection service 410 is a service included in integrated data services 440, as noted above. In some implementations, data protection service 410 may perform multiple functions relating to data security, including generating reports about the risk level of data volumes 451, 453, 455, actively monitoring data volumes 451, 453, 455, to detect breaches, and interacting with monitoring service 420 to determine if data from data volumes 451, 453, 455, has been found on dark web 430. As such, data protection service 410 is representative of an end-to-end service that protects data at various stages (i.e., before, during, and after a breach occurs). Data protection service 410 may provide the end-to-end service by working in conjunction with storage service 460, where storage service 460 and data protection service 410 are part of the same overall service (data infrastructure service 470). In other systems, enterprise systems may have to engage with multiple services to achieve risk analysis, breach detection, and dark web monitoring. In the presently disclosed system, enterprise systems 461, 463, 465, obtain all these services from a single source (data infrastructure service 470).

In FIG. 4, data protection service 410 is shown communicating with data volumes 451, 453, 455 to read data in the data volumes (e.g., to generate risk reports and to generate semantic descriptions of data items). However, it is noted that in some instances, an enterprise system (such as enterprise system 461, 463, 465) may opt out of sharing data with data protection service 410. Thus, in some operational scenarios, data protection service 410 does not read the data in data volumes 451, 453, 455. In such cases, data protection service 410 may perform “downstream” data protection processes, in which enterprise systems 461, 463, 465 play a more prominent role in detecting breaches. Upstream processes described herein include processes 200, 500, 900, and 1300. Downstream processes described herein include processes 700, 1100 and 1500.

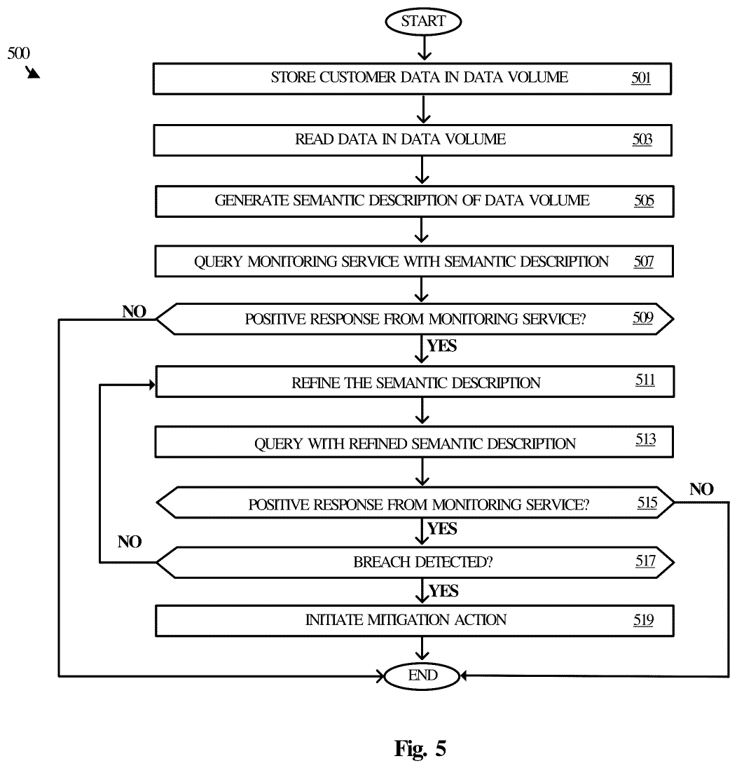

FIG. 5 illustrates a data protection process performed by data infrastructure service 470, represented by process 500. Process 500 is employed by a computing device, an example of which is provided by computing system 1701 of FIG. 17. Process 500 may be implemented in program instructions (software and/or firmware) by one or more processors of the computing device. The program instructions direct the computing device to operate as follows, referring parenthetically to the steps in FIG. 5.

To begin, data infrastructure service 470 stores enterprise data in data volume 451, 453, or 455 (step 501). The enterprise data may be data received from one of enterprise systems 461, 463, or 465. Step 501 is performed by storage service 460 of data infrastructure service 470.

Next, data infrastructure service 470 reads data items in data volume 451, 453, or 455 (step 503). Step 503 is performed by data protection service 410 of data infrastructure service 470. Data infrastructure service 470 reads the data to generate semantic descriptions of the data items in steps 505 and 511 of process 500.

Steps 505-519 of process 500 are performed by data protection service 410. Steps 505-519 may be substantially similar to corresponding steps 201-215 of process 200 described in relation to FIG. 2 above. As such, each of these steps is briefly set forth below.

After reading the data, data protection service 410 generates a semantic description of data volume 451, 453, or 455 (step 505). Data protection service 410 queries monitoring service 420 with the semantic description (step 507). Data protection service 410 determines if a positive response is received from monitoring service 420 (step 509). If “NO,” process 500 ends. If “YES,” process 500 continues at step 511. Data protection service 410 refines the semantic description (step 511). Data protection service 410 queries monitoring service 420 with the refined semantic description (step 513). Data protection service 410 determines if a positive response from monitoring service 420 (step 515). If “NO,” process 500 ends. If “YES,” process 500 continues at step 517. Data protection service 410 determines if a breach has been detected (step 517). If “NO,” process 500 returns to step 511, where the semantic query is iteratively refined. If “YES,” process 500 proceeds to step 519. Data protection service 410 initiates a mitigation action (step 519).

In some implementations the mitigation action of step 519 may include generating (at data protection service 410) an exposure report for enterprise systems 461, 463, 465. The exposure report may include the data items found on the dark web, and an estimated percentage of files from associated data volumes 451, 453, 455 that have been exfiltrated, for example. Data protections service 410 provides generated exposure reports to enterprise systems 461, 463, 465. Upon receipt, enterprise systems 461, 463, 465 may notify affected end users and shut down their access to prevent spreading the cause of the breach (e.g., ransomware) to other users.

Process 500 represents an upstream process in which the customer (i.e., enterprise system 461, 463, or 465) shares its data with data protection service 410. As such, data protection service 410 reads data in data volumes 451, 453, or 455 to generate and refine the semantic descriptions.

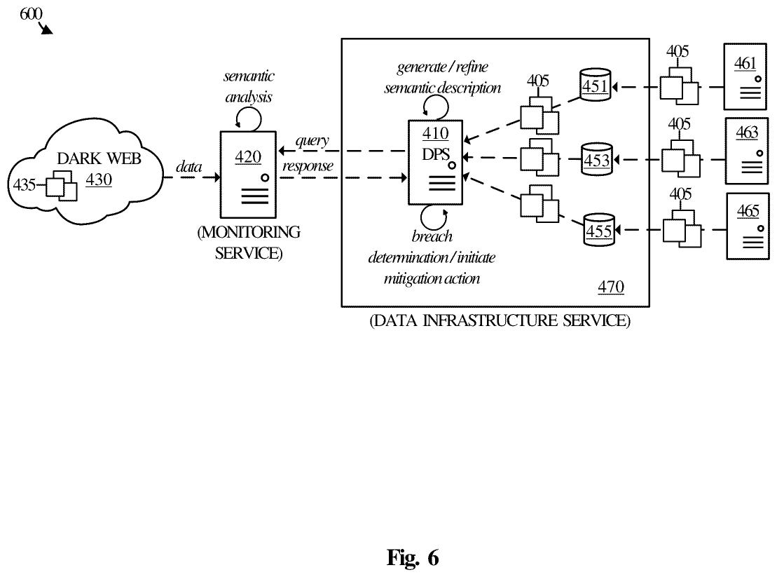

FIG. 6 illustrates an operational scenario of an application of process 500 in the context of operational environment 400 in an implementation, represented by scenario 600. Scenario 600 includes data infrastructure service 470 (including data protection service 410 and storage service 460), monitoring service 420, dark web 430, and enterprise systems 461, 463, 465.

Enterprise systems 461, 463, 465 manage a large amount of data (e.g., data items generated by users 481, 483, 485 of FIG. 4). Enterprise systems 461, 463, 465 store enterprise data items 405 in respective data volumes 451, 453, 455 of storage service 460.

Data protection service 410 generates semantic descriptions and refines the semantic descriptions (as described above in steps 505 and 507 of process 500). The semantic descriptions are generated based on enterprise data items 405 read from data volumes 451, 453, 455. Data protection service 410 also makes breach determinations and initiates mitigation actions (as described above in steps 517 and 519 of process 500). Data protection service 410 submits queries to monitoring service 420 including the semantic descriptions. Data protection service 410 receives results from monitoring service 420, where the results indicate whether data items matching the semantic description have been found on dark web 430.

Monitoring service 420 receives the queries submitted by data protection service 410. Monitoring service performs a semantic analysis to determine if any exfiltrated data items 435 matching the description are identified. To perform the semantic analysis, monitoring service 420 generates its own semantic descriptions of exfiltrated data items 435 scraped from dark web 430 and determines if the semantic descriptions in the queries are aligned with the semantic descriptions received from monitoring service 420. After performing the semantic analysis, monitoring service 420 provides the results of the semantic analysis to data protection service 410. In some implementations, the results may be formatted as a binary positive-or-negative response (e.g., a “YES” response indicating that data items matching the semantic description have been found on dark web 430, or a “NO” response indicating that the semantic description does not describe and exfiltrated data items 435). Based on the results, data protection service 410 makes breach determinations and initiates mitigation actions (steps 517 and 519 of process 500).

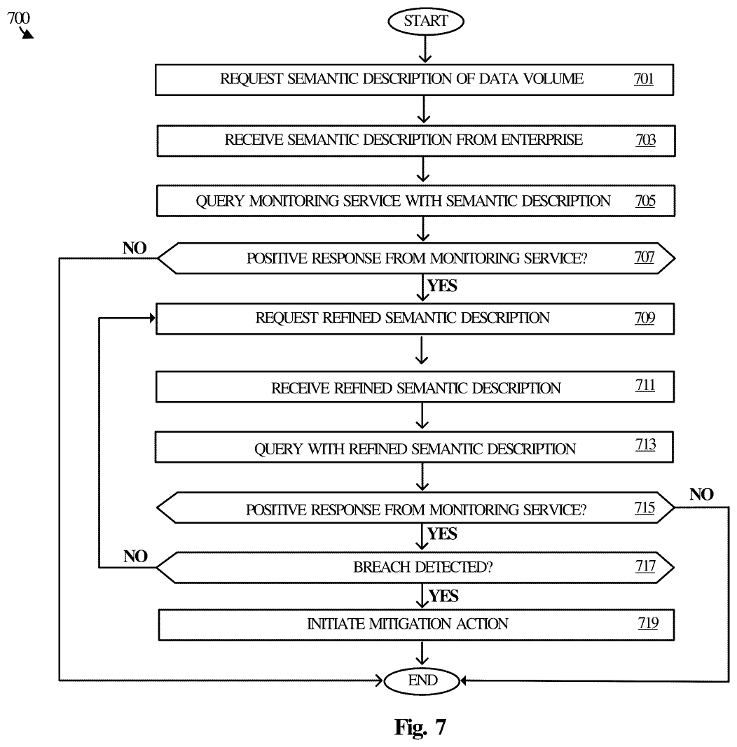

FIG. 7 illustrates a data protection process performed by data protection service 410, represented by process 700. Process 700 is employed by a computing device, an example of which is provided by computing system 1701 of FIG. 17. Process 700 may be implemented in program instructions (software and/or firmware) by one or more processors of the computing device. The program instructions direct the computing device to operate as follows, referring parenthetically to the steps in FIG. 7.

To begin, data protection service 410 requests for enterprise system 461, 463, or 465 to provide a semantic description of data volume 451, 453, or 455 (step 701).

Data protection service 410 receives, in response, a semantic description from enterprise system 461, 463, or 465 (step 703). Enterprise system 461, 463, 465 may generate the semantic description by generating a natural language description of a portion of data items within data volume 451, 453, 455. For example, if data volume 451, 453, 455 includes a set of documents relating to self-driving cars, the generated semantic description might be “design documents relating to self-driving cars manufactured by X company.” To generate the semantic description, enterprise system 461, 463, or 465 may utilize various techniques such as machine learning, Natural Language Processing (NLP), semantic analysis, rules-based systems, and hybrid approaches.

Data protection service 410 queries monitoring service 420 with the semantic description (step 705).

Data protection service 410 determines if a positive response is received from monitoring service 420 (step 707). If “NO,” process 700 ends. If “YES,” process 700 continues at step 709.

Data protection service 410 requests a refined semantic description from the customer (step 709).

Data protection service 410 receives a refined semantic description from the customer (step 711). Data protection service 410 queries monitoring service 420 with the refined semantic description (step 713). Data protection service 410 determines if a positive response from monitoring service 420 (step 715). If “NO,” process 700 ends. If “YES,” process 700 continues at step 717. Data protection service 410 determines if a breach has been detected (step 717). If “NO,” process 700 returns to step 709 where the semantic query is iteratively refined. If “YES,” process 500 proceeds to step 719.

It is noted that process 700 is substantially similar to process 500. Process 700 is different in that data protection service 410 requests and receives semantic descriptions from enterprise systems 461, 463, 465, instead of generating semantic descriptions. This is applicable in downstream arrangements in which enterprise systems 461, 463, 465 opt out of sharing data with data protection service 410, thus precluding data protection service 410 from generating semantic descriptions of the data. Accordingly, data protection service 410 may facilitate identifying exfiltrated data items even where data is not shared.

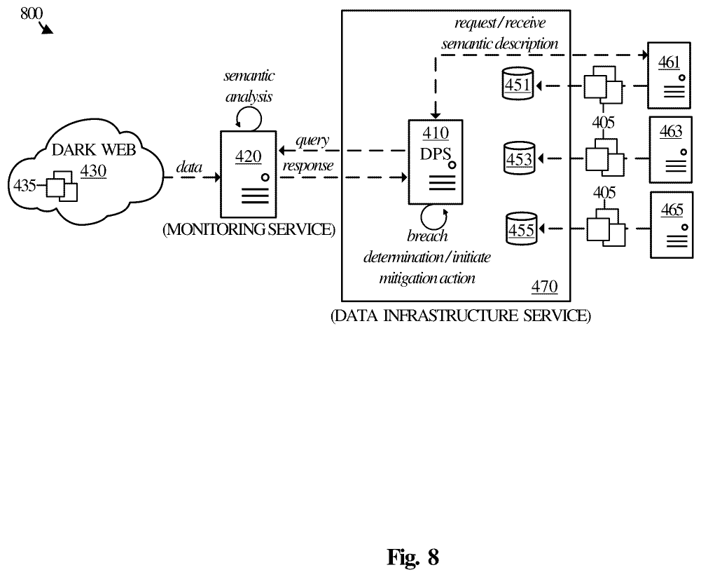

FIG. 8 illustrates an operational scenario of an application of process 700 in the context of operational environment 400 in an implementation, represented by scenario 800. Scenario 800 includes data infrastructure service 470 (including data protection service 410 and storage service 460), monitoring service 420, dark web 430, and enterprise systems 461, 463, 465.

Enterprise systems 461, 463, 465 manage a large amount of data (e.g., data items generated by users 481, 483, 485 of FIG. 4). Enterprise systems 461, 463, 465 store enterprise data items 405 in respective data volumes 451, 453, 455 of storage service 460.

Data protection service 410 submits, to enterprise systems 461, 463, 465, queries requesting semantic descriptions of data volumes 451, 453, 455 (see step 701 of process 700). Enterprise systems 461, 463, 465 generate semantic descriptions of data volumes 451, 453, 455. The semantic descriptions are generated based on enterprise data items 405 read from data volumes 451, 453, 455.

Data protection service 410 also makes breach determinations and initiates mitigation actions (steps 717 and 719 of process 700). Data protection service 410 submits queries to monitoring service 420 including the semantic descriptions. Data protection service 410 receives results from monitoring service 420, where the results indicate whether data items matching the semantic description have been found on dark web 430.

Monitoring service 420 receives the queries submitted by data protection service 410. Monitoring service performs a semantic analysis to determine if it has found any documents matching the semantic description on dark web 430. To perform the semantic analysis, monitoring service 420 may generate its own semantic descriptions of data items (e.g., exfiltrated data items 135) it has scraped from dark web 430 and determines if the semantic descriptions in the queries match the semantic descriptions generated by monitoring service 420. After performing the semantic analysis, monitoring service 420 provides the results of the semantic analysis to data protection service 410. In some implementations, the results may be formatted as a binary positive-or-negative response (e.g., a “Yes” response indicating that data items matching the semantic description have been found on dark web 430, or a “NO” response indicating that no data items found on dark web 430 match the semantic description). Based on the results, data protection service 410 makes breach determinations and initiates mitigation actions (as described above in steps 717 and 719 of process 700).

FIG. 9 illustrates a data protection process performed by data protection service 410, represented by process 900. Process 900 is employed by a computing device, an example of which is provided by computing system 1701 of FIG. 17. Process 900 may be implemented in program instructions (software and/or firmware) by one or more processors of the computing device. The program instructions direct the computing device to operate as follows, referring parenthetically to the steps in FIG. 9.

To begin, data protection service 410 identifies a set of enterprise data items 405 in data volume 451, 453, or 455 that contain key values (step 901). Since process 900 is directed to an upstream process, data protection service 410 has access to data volumes 451, 453, and 455. As such, monitoring service 420 reads enterprise data items 405 from data volumes 451, 453, and 455 to identify the set of data items containing key values.

A key value is a piece of data that is associated with a specific identifier (a key). For instance, the key “name,” could be associated with key values “John McDonald” and “Jane King.” Again, with a key “social security number,” a key value could include a specific social security number such as 123-45-6789.

Data volumes 451, 453, 455 may include key values in both structured and unstructured data. Structured data is organized data adhering to a predefined data model in which key values are associated with their keys. An example of structured data is a table including a list of names, addresses, and social security numbers. In unstructured data, on the other hand, key values may not be clearly associated with specific identifiers (i.e., keys). Unstructured data is data that does not adhere to a predefined data model, and may include various types of data including, for example, plain text, PDF documents, images, and videos. As understood herein, unstructured data may include key values (for example, the signature page of a document may include several names, numbers, and addresses).

Identifying the data items that contain key values in step 901 may include identifying key values in both structured and unstructured data within enterprise data items 405. For structured data, data protection service 410 identifies the key values according to the predefined data structure of enterprise data item 405. To identify key values in unstructured data, data protection service 410 may employ various techniques including natural language processing, machine learning algorithms, named entity recognition systems, text mining techniques, and optical character recognition (OCR).

Next, data protection service 410 selects a set of key values from the set of data items (step 903). A given enterprise data item 405 may include many key values (e.g., included in a list of names and addresses). In some implementations of step 903, data protection service 410 selects only one of the key values in each enterprise data item 405 of the set. However, it is noted that in other implementations, data protection service 410 may select a portion of key values from each data item according to predefined rules. For example, in some implementations, data protection service 410 may select up to a specific number (e.g., five or ten) of key values from each enterprise data item 405 in the set. In other implementations, data protection service 410 may select a percentage (e.g., 5% or 10%) of total key values in a given enterprise data item 405. For example, if an enterprise data item 405 contains one-hundred key values, data protection service 410 may select 5 of these values (where the predefined rules indicate that 5% of key values are selected). All the implementations discussed in this paragraph are directed to tailoring the queries (of step 905 below) provided to data protection service 410. Specifically, instead of querying monitoring service 420 with all key values present in data volumes 451, 453, 455, breaches may be detected by querying with a smaller number of key values. This results in computer resource savings since fewer queries and results are processed by data protection service 410. Further, monetary savings may be achieved since monitoring service 420 may charge customers based on the number of key values queried.

Next, data protection service 410 queries monitoring service 420 with the selected set of key values (step 905). Specifically, data protection service 410 queries monitoring service 420 for an indication of which (if any) key values in the set of key values have been identified on dark web 430.

Next, data protection service 410 receives results from monitoring service 420 (step 907). The results may include a positive or negative response for each key value in the set of key values from step 905.

Next, data protection service 410 determines if a breach has been detected based on the results (step 909). In some implementations a determination that a breach has been detected may be based on a determination that at least one of the key values has been identified on dark web 430. If a breach has not been detected, process 900 ends. If a breach has been detected, process 900 continues to step 911.

If a breach is detected, data protection service 410 estimates the extent of the breach (step 911). As set forth in the above steps, data protection service 410 queries monitoring service 420 with a selection of a set key values from data volume 451, 453, or 455, where the data volume includes a remainder of key values for which queries are not submitted. As such, estimating the extent of the breach may include estimating which of the remainder of key values has been subject to the data breach.

Data protection service 410 may utilize various methods to estimate the number of key values that have been exfiltrated in a data breach in various implementations. In one implementation (e.g., where the set of key values includes only one key value from each data item), data protection service 410 may assume that, if a key value has received a positive response from monitoring service 420, all other key values in the associated data item have also been exfiltrated in the data breach—and conversely, if data protection service 410 receives a negative response for a key value, it will assume that no other key values from the associated data item were exfiltrated in the data breach. In implementations in which multiple key values are selected from each data item (as discussed in step 903 above), data protection service 410 may determine, for a given data item, a percentage of queried key values that have been exfiltrated and estimate that the same percentage of remaining key values has also been exfiltrated. (It is noted that in some instances, key values of a data item may be exfiltrated selectively. This can occur, for example, when data is stored in a segmented fashion.)

The estimated extent of the breach includes an estimated percentage of key values in data volume 451, 453, or 455 that have been exfiltrated, according to some implementations. Data protection service 410 may consider various factors in addition to the results from monitoring service 420 to estimate the percentage, such as the probability that a given key value could have been exfiltrated from a different source (for example, a person's social security number might be stored in various databases associated with different organizations).

After estimating the extent of the breach, data protection service 410 generates an exposure report (step 913). The exposure report includes the estimated extent of the data breach and may further include an indication of which key values have been exfiltrated. Once the exposure report is generated, data protection service 410 provides the exposure report to enterprise system 461, 463, or 465. Following this, enterprise system 461, 463, or 465 may take various actions to address the breach (for example, notifying affected users and increasing security measures).

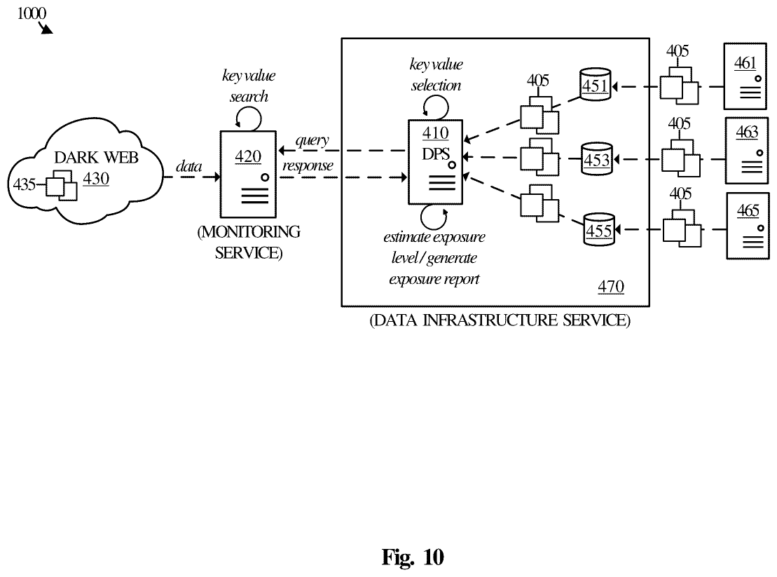

FIG. 10 illustrates an operational scenario of an application of process 900 in the context of operational environment 400 in an implementation, represented by scenario 1000. Scenario 1000 includes data infrastructure service 470 (including data protection service 410 and storage service 460), monitoring service 420, dark web 430, and enterprise systems 461, 463, 465.

Enterprise systems 461, 463, 465 manage a large amount of data (e.g., data items generated by users 481, 483, 485 of FIG. 4). Enterprise systems 461, 463, 465 store enterprise data items 405 in respective data volumes 451, 453, 455 of storage service 460.

Data protection service 410 makes a key value selection for each data volume 451, 453, 455, as described in step 903 of process 900 above. Data protection service 410 queries monitoring service 420 with the set of key values, as discussed in step 905 of process 900 above.

Monitoring service 420 receives the queries and performs a key value search. In some implementations, monitoring service 420 may maintain a database of key values found on dark web 430; thus, performing a key value search may include looking for the key values in the database of maintained key values. In other implementations, monitoring service 420 may actively search dark web 430 for key values received in queries from data protection service 410. After performing the key value search, monitoring service 420 returns results of the search to data protection service 410 (as discussed in step 907 of process 900 above). Data protection service 410 estimates exposure levels and generates exposure reports, as discussed in steps 911 and 913 of process 900 above). Data protection service 410 provides the exposure reports to associated enterprise systems 461, 463, 465.

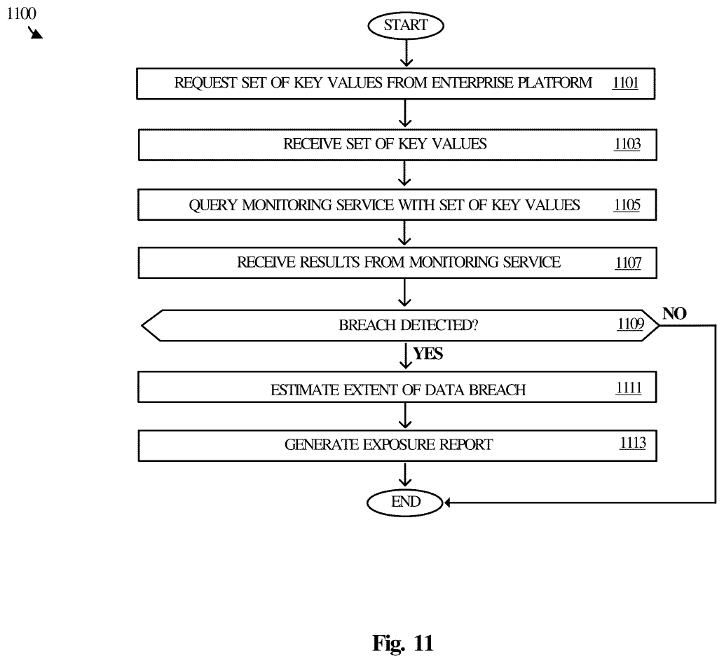

FIG. 11 illustrates a data protection process performed by data protection service 410, represented by process 1100. Process 1100 is employed by a computing device, an example of which is provided by computing system 1701 of FIG. 17. Process 1100 may be implemented in program instructions (software and/or firmware) by one or more processors of the computing device. The program instructions direct the computing device to operate as follows, referring parenthetically to the steps in FIG. 11.

To begin, data protection service 410 requests a set of key values from enterprise system 461, 463, or 465 (step 1101). The request may indicate a request for the enterprise system 461, 463, or 465 to provide only one key value from each data item in data volume 451, 453, 455, according to some implementations. In other implementations, data protection service 410 may request key values selected from each data item according to predefined rules. For example, in some implementations, data protection service 410 may request up to a specific number (e.g., five or ten) of key values from each data item. In other implementations, data protection service 410 may request a percentage (e.g., 5% or 10%) of total key values in a given data item. All these implementations are directed to data protection service 410 obtaining a select set of key values in order to tailor queries, where tailoring of queries is discussed in process 900 above. Next, data protection service 410 receives a set of key values from enterprise system 461, 463, or 465 generated by the enterprise system in accordance with the request (step 1103).

Steps 1105-1113 of process 1100 are performed by data protection service 410. Steps 1105-1113 may be substantially the same as corresponding steps 905-913 of process 900 described in relation to FIG. 9 above. As such, each of these steps is set forth briefly below.

Upon receiving the set of key values, data protection service 410 queries monitoring service 420 with the set of key values (step 1105). Next, data protection service 410 receives results from monitoring service 420 (step 1107). Next, data protection service 410 determines if a breach is detected based on the results (step 1109). If “NO,” process 1100 ends. If “YES,” process 1100 continues at step 1111. Data protection service 410 estimates the extent of the breach (step 1111). Data protection service generates an exposure report (step 1113).

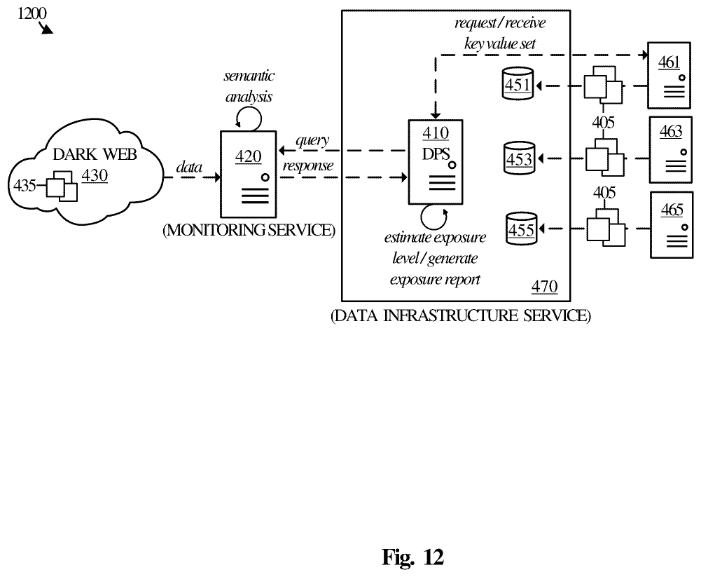

FIG. 12 illustrates an operational scenario of an application of process 900 in the context of operational environment 400 in an implementation, represented by scenario 1200. Scenario 1200 includes data infrastructure service 470 (including data protection service 410 and storage service 460), monitoring service 420, dark web 430, and enterprise systems 461, 463, 465.

In scenario 1200, data protection service 410 submits a request to enterprise system 461, 463, or 465 for a set of key values, as discussed in step 1101 of process 1100 above. Enterprise system 461, 463, or 465 selects a set of key values from data volume 451, 453, or 455 according to the request, and responds to data protection service 410 with the set of key values.

Data protection service 410 queries monitoring service 420 with the set of key values, as described in step 1105 of process 1100 above.

Monitoring service 420 receives the queries and performs a key value search. In some implementations, monitoring service 420 may maintain a database of key values found on dark web 430; thus, performing a key value search may include looking for the key values in the database of maintained key values. In other implementations, monitoring service 420 may actively search dark web 430 for key values received in queries from data protection service 410. After performing the key value search, data protection service 410 returns results of the search to data protection service 410 (as discussed in step 1107 of process 1100 above). Data protection service 410 estimates exposure levels and generates exposure reports, as discussed in steps 1111 and 1113 of process 1100 above). Data protection service 410 provides the exposure reports to associated enterprise systems 461, 463, 465.

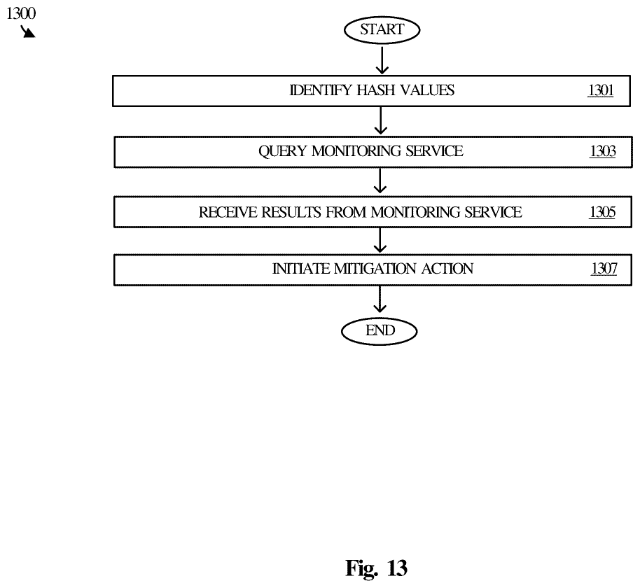

FIG. 13 illustrates a data protection process performed by data protection service 410, represented by process 1300. Process 1300 is employed by a computing device, an example of which is provided by computing system 1701 of FIG. 17. Process 1300 may be implemented in program instructions (software and/or firmware) by one or more processors of the computing device. The program instructions direct the computing device to operate as follows, referring parenthetically to the steps in FIG. 13.

To begin, data protection service 410 identifies hash values for a set of enterprise data items 405 in data volume 451, 453, 455 (step 1301). The set of enterprise data items 405 may include one or more enterprise data items 405. Identifying the one or more first hash values includes data protection service 410 reading enterprise data items 405 from data volumes 451, 453, 455, and generating the one or more first hash values using a hashing algorithm. As such, process 1300 represents an upstream process in which data protection service 410 has access to enterprise data items 405 from data volumes 451, 453, 455.

Next, data protection service 410 queries monitoring service 420 with the identified hash values (step 1303).

Next, data protection service 410 receives results from monitoring service 420 (step 1305). The results may include an indication that a subset of enterprise data items 405 has been exfiltrated to dark web. The subset may include one or more enterprise data items 405 from the set of enterprise data items 405. Monitoring service 420 may determine the results by generating hash values of exfiltrated data items 435 using the same hashing algorithm utilized by data protection service 410. Monitoring service 420 identifies the subset by identifying matches between the queried hash values with generated with the received hash values.

Next, data protection service 410 initiates a mitigation action (step 1307). The mitigation action may include estimating the extent of a data breach based at least on a number of enterprise data items in the subset and generating a report indicating the extent of the data breach. Data protection service 410 provides the generated report to enterprise system 461, 463, 465.

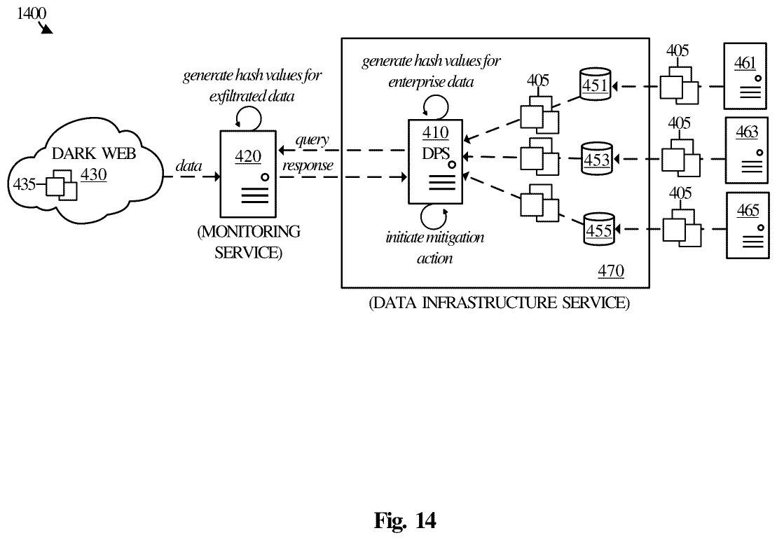

FIG. 14 illustrates an operational scenario of an application of process 1300 in the context of operational environment 400 in an implementation, represented by scenario 1400. Scenario 1400 includes data infrastructure service 470 (including data protection service 410 and storage service 460), monitoring service 420, dark web 430, and enterprise systems 461, 463, 465.

In scenario 1400, data protection service 410 generates hash values for enterprise data items 405 read from data volumes 451, 453, 455, as discussed in step 1301 of process 1300 above. Data protection service 410 queries monitoring service 420 with the generated hash values, as discussed in step 1303 of process 1300 above.

Monitoring service 420 generates hash values for exfiltrated data items 435. Monitoring service 420 provides a response to data protection service 410 based on a comparison between the received hash values with the generated hash values, as discussed in step 1305 of process 1300 above. Data protection service 410 initiates a mitigation action, as discussed in step 1307 of process 1300 above.

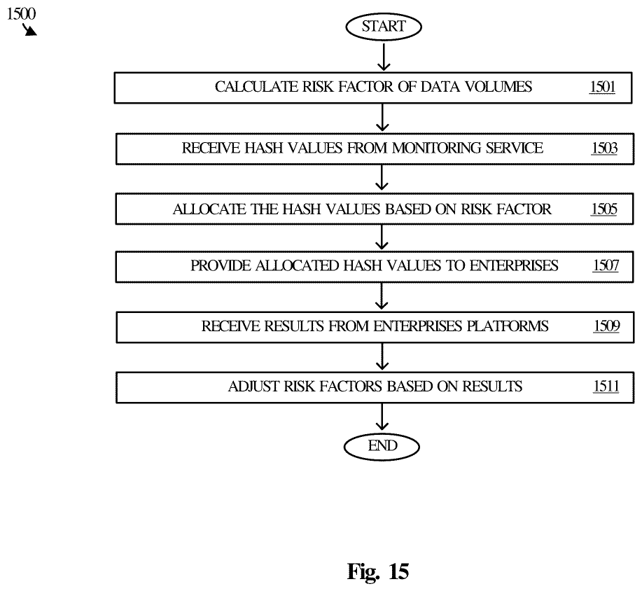

FIG. 15 illustrates a data protection process performed by data protection service 410, represented by process 1500. Process 1500 is employed by a computing device, an example of which is provided by computing system 1701 of FIG. 17. Process 1500 may be implemented in program instructions (software and/or firmware) by one or more processors of the computing device. The program instructions direct the computing device to operate as follows, referring parenthetically to the steps in FIG. 15.

To begin, data protection service 410 calculates a risk factor for customers, and more specifically, enterprise systems 461, 463, 465 associated with each customer (step 1501). The risk factor indicates a likelihood that a data in a particular data volume (e.g., data volumes 451, 453, 455 of FIG. 4) will be subject to data exfiltration in a data breach. The risk factor can be based on various data points, including the frequency of file transfers, and the security measures in place. The risk factor may be expressed in terms of percentiles. For example, a 90% risk level indicates that a data volume is more likely to be subject to a data breach than 90% of the multiple data volumes maintained by various organizations. By way of example, enterprise system 461 may be assigned an 80% risk factor, enterprise system 463 a 50% risk factor, and enterprise system 465 a 20% risk factor.

Data protection service 410 then receives data points from monitoring service 420 (step 1503). The data points may include, for example, a set of hash values for various data items identified on dark web 430. Monitoring service 420 may periodically generate file hashes for a selection of data items scraped from dark web 430. For example, if monitoring service 120 obtains one-thousand new files from dark web 430, monitoring service 420 may generate a hash value for each of the new files and provide the hash values to data protection service 110.

Data protection service 410 then allocates the data points to the customers based on the risk factors (step 1505). Specifically, data protection service 410 may allocate proportionally more data points to customers with a higher risk factor, and fewer data points to customers with a lower risk factor. For example, if data protection service 410 received one-thousand hash values, it may allocate the hash values in a proportional manner such that eight-hundred of the hash values are allocated to enterprise system 461 (having the 80% risk factor), five-hundred are allocated to enterprise system 463 (having the 50% risk factor) and two-hundred are allocated to enterprise system 465 (having the 20% risk factor). Data protection service 410 may select the allocated hash values randomly in some implementations.

Data protection service 410 then provides the allocated hash values to the customers (step 1507). Once the customer (e.g., enterprise systems 461, 463, 465) receives the hash values, the customer may determine whether any of the allocated hash values match a hash value of one of its own data items (e.g., in data volumes 451, 453, 455 of FIG. 4). It is noted that the customer may generate hash values for its own data items using the same hashing algorithm used by monitoring service 420. As such, customers may identify matching hash values to determine if their data items have been exfiltrated in a data breach. Process 1100 represents a downstream process in that customers may identify data breaches without giving data protection service 410 access to its data.

In performing processing operations to determine whether data has been exfiltrated, enterprise systems 461, 463, 465 balance data security concerns with efficient use of compute resources. An enterprise system 461, 463, 465 that has a high-risk factor may choose to increase the computer resources allocated to data security (and thus, for example, process a higher number of hash values obtained from data protection service 410). Conversely, if an enterprise system 461, 463, 465 has a low risk factor, it may determine to allocate less computer resources to data security (and thus process fewer hash values). As such, data protection service 410 tailors the number of hash values provided to enterprise systems 461, 463, 465 based on the risk factor, as discussed above.

Data protection service 410 receives results from enterprise systems 461, 463, 465 (step 1509). The results include the results of a hash value comparison performed by enterprise systems 461, 463, 465. Specifically, enterprise systems 461, 463, 465 may generate hash values for data items in their associated data volumes 451, 453, 455 (see FIG. 4). Hash values are specific identifiers for data items, as discussed in the preceding figures. Enterprise systems 461, 463, 465 may generate hash values using the same hashing algorithm as the monitoring service 420. As such, enterprise systems 461, 463, 465 may identify data breaches by comparing the hash values received to the generated hash values. Thus, enterprise systems 461, 463, 465 identify that a data item has been exfiltrated to dark web 430 by identifying that its associated generated hash value matches a received hash value. The results enterprise systems 461, 463, 465 provide to data protection service 410 may indicate which data items (if any) have been identified as being exfiltrated, based on the hash value comparison.

Upon receiving the results, data protection service 410 adjusts the risk factors associated with enterprise systems 461, 463, 465 (step 1511). For example, if an enterprise system reports that no exfiltration has been identified, data protection service 410 may calculate a reduced risk factor (e.g., down from 40% to 30%). Alternatively, if an enterprise system reports that seven out of eight data items have been exfiltrated, data protection service may calculate an increased risk factor (e.g., up from 70% to 80%). As such, the risk factors may be continually adjusted such that each enterprise system 461, 463, 465 is allocated an appropriate number of hash values.

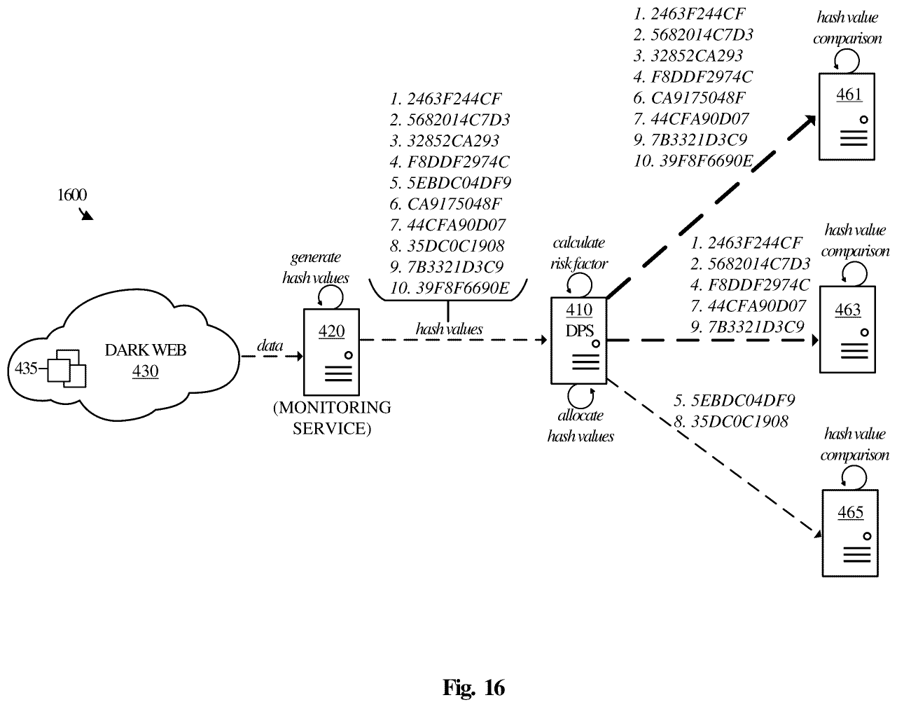

FIG. 16 illustrates an operational scenario of an application of process 1500 in the context of operational environment 400 in an implementation, represented by scenario 1600. Scenario 600 includes data infrastructure service 470 (including data protection service 410 and storage service 460), monitoring service 420, dark web 430, and enterprise systems 461, 463, 465.

In scenario 1600, data protection service 410 calculates a risk factor for enterprise systems 461, 463, 465, as described above in step 1101 of process 1100. FIG. 16 shows dotted lines with varying thicknesses, indicating various risk factors. For example, enterprise system 461 may have a high risk factor (e.g., 80%), enterprise system 463 a medium risk factor (e.g., 50%) and enterprise system 465 a low risk factor (e.g., 20%).

Monitoring service 420 obtains exfiltrated data items 435 from dark web 430. Monitoring service 420 generates hash values for the data items it obtains. In the example in FIG. 12, monitoring service 420 provides ten hash values in hexadecimal format to data protection service 410. However, it is noted that hash values may be in another format (e.g., binary) in other implementations. Further, while ten hash values are portrayed in FIG. 12 for illustration service, monitoring service 420 may provide larger numbers of hash values to data protection service 410. Each hash value is a specific identifier for a data item, which monitoring service 420 generates using a hashing algorithm. A hash value may be generated for an entire data item or a portion of a data item.

Once data protection service 410 receives the hash values (as described in step 1503 of process 1500), it allocates the hash values to enterprise systems 461, 463, 465 based on the calculated risk factors (as described in step 1505 of process 1500). Data protection service 410 then provides the allocated hash values to enterprise systems 461, 463, 465 (as discussed in step 1507 of process 1500 above).

Once enterprise systems 461, 463, 465 receive the allocated hash values, they perform a hash value comparison to identify data items that have been exfiltrated in a data breach (as discussed in step 1509 of process 1500 above). Enterprise system 461 463, 465 may return the results of the hash value comparison to data protection service 410, which in turn adjusts their associated risk factors (as discussed in 1509 and 1511 of process 1500 above).

FIG. 17 illustrates computing system 1701, which is representative of any system or collection of systems in which the various applications, processes, services, and scenarios disclosed herein may be implemented. Examples of computing system 1701 include, but are not limited to server computers, web servers, cloud computing platforms, and data center equipment, as well as any other type of physical or virtual server machine, container, and any variation or combination thereof. (In some examples, computing system 1701 may also be representative of desktop and laptop computers, tablet computers, and the like.)

Computing system 1701 may be implemented as a single apparatus, system, or device or may be implemented in a distributed manner as multiple apparatuses, systems, or devices. Computing system 1701 includes, but is not limited to, processing system 1702, storage system 1703, software 1705, communication interface system 1707, and user interface system 1709. Processing system 1702 is operatively coupled with storage system 1703, communication interface system 1707, and user interface system 1709.

Processing system 1702 loads and executes software 1705 from storage system 1703. Software 1705 includes and implements data protection processes 1706, which are representative of the processes discussed with respect to the preceding Figures, such as processes 200, 500, 700, 900, 1100, 1300, and 1500. When executed by processing system 1702, software 1705 directs processing system 1702 to operate as described herein for at least the various processes, operational scenarios, and sequences discussed in the foregoing implementations. Computing system 1701 may optionally include additional devices, features, or functionality not discussed for purposes of brevity.

Referring still to FIG. 17, processing system 1702 may include a microprocessor and other circuitry that retrieves and executes software 1705 from storage system 1703. Processing system 1702 may be implemented within a single processing device but may also be distributed across multiple processing devices or sub-systems that cooperate in executing program instructions. Examples of processing system 1702 include general purpose central processing units, microcontroller units, graphical processing units, application specific processors, integrated circuits, application specific integrated circuits, and logic devices, as well as any other type of processing device, combinations, or variations thereof.

Storage system 1703 may comprise any computer readable storage media readable by processing system 1702 and capable of storing software 1705. Storage system 1703 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 1703 may be implemented as a single storage device but may also be implemented across multiple storage devices or sub-systems co-located or distributed relative to each other. Storage system 1703 may comprise additional elements, such as a controller capable of communicating with processing system 1702 or possibly other systems.

Software 1705 (including data protection processes 1706) may be implemented in program instructions and among other functions may, when executed by processing system 1702, direct processing system 1702 to operate as described with respect to the various operational scenarios, sequences, and processes illustrated herein. For example, software 1705 may include program instructions for implementing data protection processes and procedures as described herein.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating a data protection service, comprising:
identifying one or more first hash values, each of the first hash values specifically identifying an enterprise data item of a plurality of enterprise data items in a data volume;
querying a monitoring service with the one or more first hash values;
receiving results from the monitoring service, wherein the results comprise an indication that at least one of the enterprise data items has been exfiltrated; and
initiating a mitigation action.

2. The method of claim 1 wherein:
the identifying the one or more first hash values comprises generating the one or more first hash values using a hashing algorithm, and
the indication that at least one of the plurality of enterprise data items has been exfiltrated to a dark web comprises an indication that at least one exfiltrated data item has an associated hash value that is the same as one of the first hash values.

3. The method of claim 1, wherein:
the identifying the one or more first hash values comprises identifying a plurality of hash values, each specifically identifying one of a plurality of enterprise data items in the data volume,
the results further comprise an indication that a subset of the plurality of enterprise data items has been exfiltrated, and
the initiating the mitigation action comprises:
estimating an extent of a data breach based at least on a number of enterprise data items in the subset, and
generating a report indicating the extent of the data breach.

4. A method of operating a data protection service comprising:
determining a risk level for each of a plurality of enterprise systems, each of the plurality of enterprise systems being associated with a data volume of a plurality of data volumes, wherein each risk level indicates a likelihood that the associated data volume will be subject to exfiltration in a data breach;
receiving, from a monitoring service, a plurality of hash values, each of the plurality of hash values specifically identifying an exfiltrated data item;
allocating a plurality of subsets of hash values, each of the subsets comprising a portion of the plurality of hash values, each of the subsets being allocated to a corresponding enterprise system of the plurality of enterprise systems, wherein each subset comprises a number of hash values determined based on the risk level of the corresponding enterprise system; and
providing each subset to its corresponding enterprise system.

5. The method of claim 4 wherein the plurality of hash values comprises a first plurality of hash values, the method further comprising:
receiving results from a first enterprise system of the plurality of enterprise systems, wherein:
the results indicate a determination that one or more enterprise data items in the associated data volume has been exfiltrated, and
the results are generated by first enterprise system based on a comparison of the subset of hash values with a second plurality of hash values, the second plurality of hash values being generated by the first enterprise system, each of the second plurality of hash values specifically identifying an enterprise data item in the associated data volume.

6. The method of claim 5 further comprising:
adjusting the risk level of the first enterprise system based on the results.

7. A method of operating a data protection service, comprising:
identifying a set of key values, each key value being selected from a different enterprise data item from a plurality of enterprise data items in a data volume owned by an enterprise system;
querying a monitoring service with the set of key values;
receiving results from the monitoring service, wherein the results indicate which key values in the set of key values have been exfiltrated to a dark web;
estimating, based on the results, an exposure level of the data volume; and
generating an exposure report indicating the estimated exposure level.

8. The method of claim 7, wherein the identifying the set of key values comprises:
identifying a set of the plurality of enterprise data items that contain key values by reading the plurality of enterprise data items in the data volume, and
selecting one key value from each data item in the set.

9. The method of claim 7 wherein the identifying the set of key values comprises:
submitting, to the enterprise system, a request for the set of key values, and
receiving, from the enterprise system, the set of key values.
